(19) United States
(12) Patent Application Publication
(10) Pub. No.: US 2023/0202811 A1
(43) Pub. Date: Jun. 29, 2023

(54) VEHICLE LIFT SYSTEM WITH FEATURE SIMPLIFICATION

(71) Applicant: Gray Manufacturing Company, Inc., St. Joseph, MO (US)

(72) Inventors: Raymond W. Karleskint, Clarksdale, MO (US); Larry M. Jaipaul, Clarence, NY (US); Stephen J. Rucker, Savannah, MO (US)

(21) Appl. No.: 18/068,655

(22) Filed: Dec. 20, 2022

Related U.S. Application Data
(60) Provisional application No. 63/294,586, filed on Dec. 29, 2021.

(51) Int. Cl. B66F 7/20

(52) U.S. Cl. CPC B66F 7/20; B66F 2700/05; B66F 2700/123

(57) ABSTRACT

A vehicle lift comprising a base, a carriage configured to receive a portion of a vehicle, and an actuator configured to vertically raise and lower the carriage relative to the base. The vehicle lift is configured to send and receive wireless signals. The vehicle lift further comprises a processor configured to (i) control the actuator, and (ii) process the wireless signals.

### CROSS-REFERENCE TO RELATED APPLICATIONS

This non-provisional patent application claims priority to U.S. Provisional Patent Application Ser. No. 63/294,586, filed Dec. 29, 2021, and entitled WIRELESS PORTABLE VEHICLE LIFT WITH FEATURE SIMPLIFICATION. The entire disclosure of the above-identified provisional patent application is hereby incorporated by reference into this non-provisional patent application.

### BACKGROUND

### 1. Field of the Invention

The present invention relates generally to a vehicle lift system. More particularly, the invention concerns a vehicle lift system comprising one or more portable vehicle lifts that each use a single processor to operate the respective lift.

### 2. Description of the Prior Art

The need to lift a vehicle from the ground for service work is well established. For instance, it is often necessary to lift a vehicle for tire rotation or replacement, steering alignment, oil changes, brake inspections, exhaust work, and other automotive maintenance. Traditionally, lifting a vehicle has been accomplished through the use of equipment that is built-into a service facility, such as lift units with the hydraulic actuator(s) installed below a surface of the service facility's floor or two and four post-type lift systems installed on the floor surface of the service facility. These built-in units are located at a fixed location at the service facility and adapted to engage the vehicle frame to lift the vehicle from the ground.

In an effort to increase the versatility and mobility of lift devices and to reduce the need to invest in permanently mounted lifting equipment, devices commonly known as a mobile column lifts (MCLs) have been developed. An example of MCLs incorporated in a vehicle lift system is described in U.S. Pat. No. 9,352,944 (the '944 Patent), which is incorporated herein by reference in its entirety.

Notably, in the past, such above-described MCLs required multiple processors to function properly. For example, for each MCL, at least one processor was generally required to operate the standard functionality of the lift (e.g., to raise and lower loads), while a separate processor was needed to facilitate communication between other lifts. In some instances, still other processors were required, such as processors for facilitating operation of display screens, remote control systems, emergency systems, etc. Given the cost and complexity of using multiple processors, there is a need for vehicle lifts that can operate properly, including operating as part of a group of lifts, with such vehicle lifts each requiring only a single processor.

### SUMMARY OF THE INVENTION

In one embodiment of the present invention, there is provided a vehicle lift comprising a base, a carriage configured to receive a portion of a vehicle, and an actuator configured to vertically raise and lower the carriage relative to the base. The vehicle lift is configured to send and receive wireless signals. The vehicle lift further comprises a processor configured to (i) control the actuator, and (ii) process the wireless signals.

In another embodiment of the present invention, there is provided a wireless portable vehicle lift system comprising at least two portable lifts. Each of the lifts comprises a base, a post, a carriage assembly, and a lifting actuator for vertically shifting the carriage assembly relative to the post. Additionally, each of the portable lifts comprises at least a first microprocessor. The lift system comprises an electronic control system for controlling the lifts. The electronic control system comprises a wireless communication system for wirelessly communicating inter-lift control signals to, from, and/or among the lifts. The first microprocessor is configured to process information related to the wireless communication system. Each of the lifts further comprises an intra-lift control system including one or more lift sensors and/or one or more lift actuators. The first microprocessor is configured to process information related to the intra-lift control system.

In another embodiment of the present invention, there is provided a vehicle lift comprising a base, a carriage configured to receive a portion of a vehicle, and an actuator configured to vertically raise and lower the carriage relative to the base. The vehicle lift further comprises a processor that includes the following: input and/or output pins, flash memory, random access memory (RAM), a clock with which the processor is configured to generate pulse-width modulated (PWM) signals, an analog-to-digital converter, and a wireless communications module configured to send and receive wireless signals.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWINGS

Embodiments of the current invention are described in detail below with reference to the attached drawing figures, wherein:

FIG. 1 is a simplified representation of a vehicle lift system utilizing four individual vehicle lifts to perform a coordinated lift of a vehicle;

FIG. 2 is a perspective view showing the front and side of a vehicle lift configured in accordance with certain embodiments of the present invention;

FIG. 3a is a back elevation view of the vehicle lift of FIG. 2;

FIG. 3b is a back elevation view of the vehicle lift of FIG. 2, with certain portions of the main housing being remove or cut away to show individual components of the lift's power and control systems;

FIG. 4 is a schematic diagram of a lift control system for the vehicle lift of FIGS. 2-3b;

FIG. 5 is a schematic diagram of a lift control processor of the lift control system of the vehicle lift from FIGS. 2-3b.

The drawing figures do not limit the current invention to the specific embodiments disclosed and described herein. While the drawings do not necessarily provide exact dimensions or tolerances for the illustrated components or structures, the drawings are to scale as examples of certain embodiments with respect to the relationships between the components of the structures illustrated in the drawings.

### DETAILED DESCRIPTION OF THE PREFERRED EMBODIMENTS

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

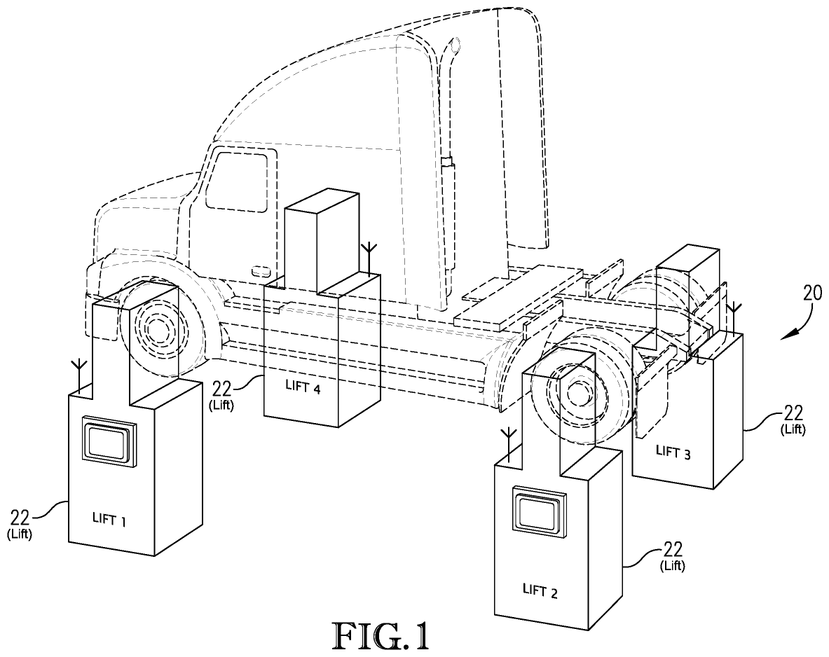

Referring now to the drawings in detail, and initially to FIG. 1, numeral 20 generally designates a wireless portable vehicle lift system having four individual portable lifts 22. This vehicle lift system 20 is similar, in certain respects, to the vehicle lift system described in the '944 Patent, which as noted above, is incorporated by reference into the present non-provisional patent application. Although FIG. 1 depicts a four lift system 20, it should be understood that any number of lifts 22 can be used. For example, the lift system 20 can employ one, two, four, six, or eight individual lifts 22. In certain embodiments, each of the individual lifts 22 is substantially identical. It should also be understood that lift system 20 is not limited for use with vehicles, but also may be used to raise or lower other objects relative to a floor or ground surface, such as aircraft, industrial machinery, shipping containers, construction subassemblies, and the like.

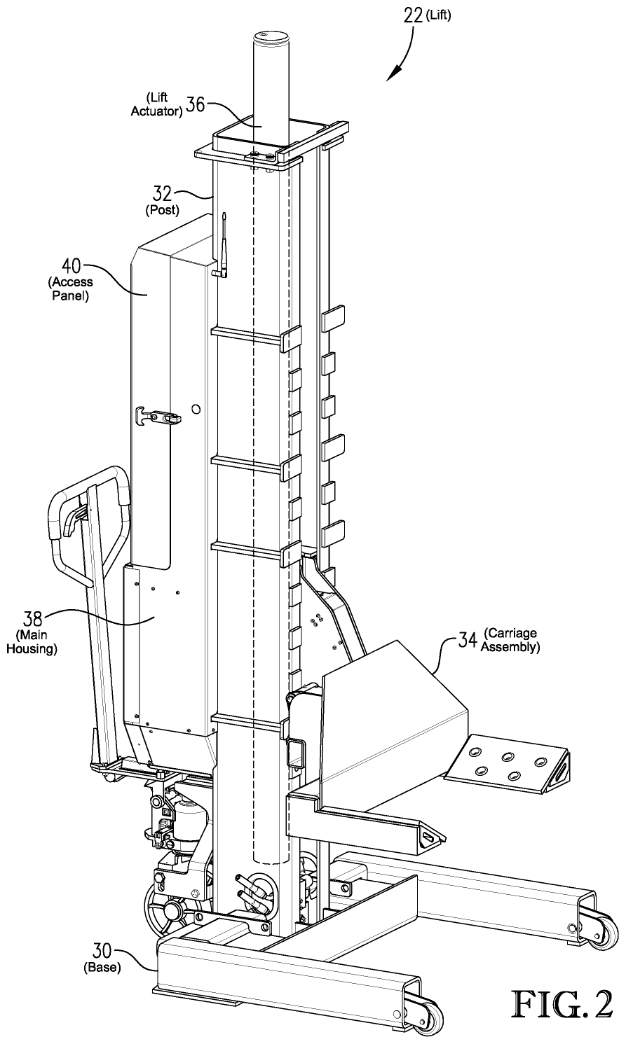

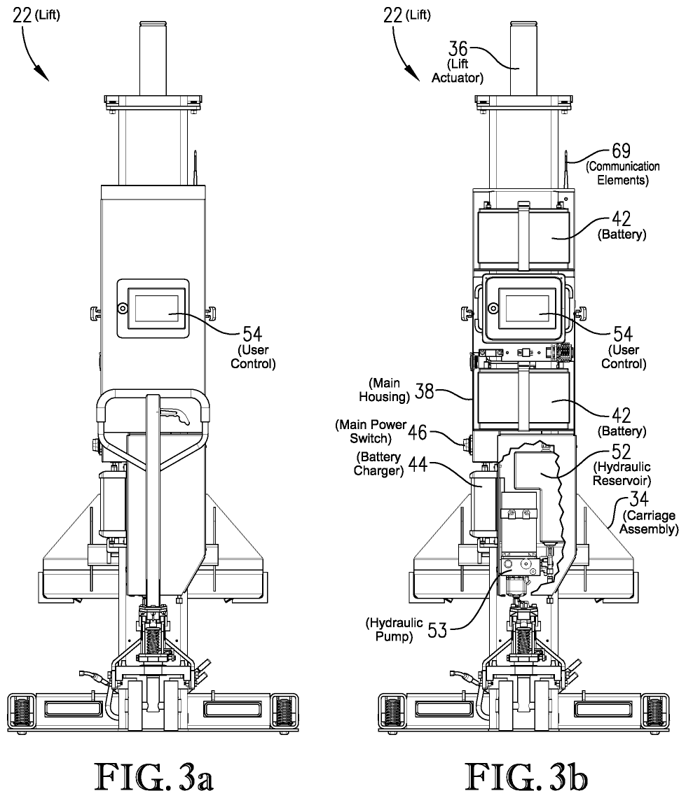

With reference to FIGS. 2, 3a, and 3b, one of the lifts 22 configured in accordance with embodiments of the present invention is illustrated. The lift 22 can include a base 30, a post 32, a carriage assembly 34, a lift actuator 36, and a main housing 38. The base 30 supports the lift 22 on the floor or the ground. The post 32 is rigidly coupled to the base 30 and extends upwardly therefrom. The carriage assembly 34 is configured to engage a wheel of a vehicle and is vertically shiftable relative to the post 32. The lift actuator 36 is received in the post 32 and is operable to vertically raise and lower the carriage assembly 34 relative to the post 32 and the base 30. The main housing 38 is attached to the post 32 and encloses many of the components that make up the control and power systems for the various components of the lift 22, as will be described in more detail below. The main housing 38 includes a removable access panel 40 for providing access to various components of such systems.

FIGS. 3a and 3b provide a view of the back of the lift 22. FIG. 3b illustrates the back of the lift 22 with the access panel 40 being removed to show certain internal components located in an upper portion of the main housing 38. In FIG. 3b, a lower portion of the main housing 38 is also cut away to show certain internal components located in the lower portion of the main housing 38. The lift 22 will generally include a lift control system (described in more detail below) that comprises (i) a single, lift processor, (ii) one or more lift control components, (iii) one or more sensors, and (iv) one or communications elements. The lift 22 may also include an electrical power supply for powering the lift, which broadly comprises one or more rechargeable batteries 42, a battery charger 44, and a main power switch 46. Further, the lift 22 may include a hydraulic power system for raising and lowering the lift actuator 36, which broadly comprises a hydraulic reservoir 52, a hydraulic pump 53, and one or more hydraulic valves. Furthermore still, the lift 22 may include a user control 54, which can be used to receive operational inputs from a user of the lift 22. The user control 54 may comprise one or more control inputs, such as buttons, switches, knobs, or the like. Alternatively, or in addition, the user control 54 may comprise a display screen for displaying various operational information to the user. The display screen may be in the form of a touchscreen, such that the user can both provide inputs to and receive information from the lift 22 using the user control 54. In some embodiments, the user control 54 may be directly integrated with the main housing 38 of the lift 22. In other embodiments, the user control 54 may be removably coupled with the main housing 38 of the lift 22, such that the user control 54 may be selectively removed from the lift 22.

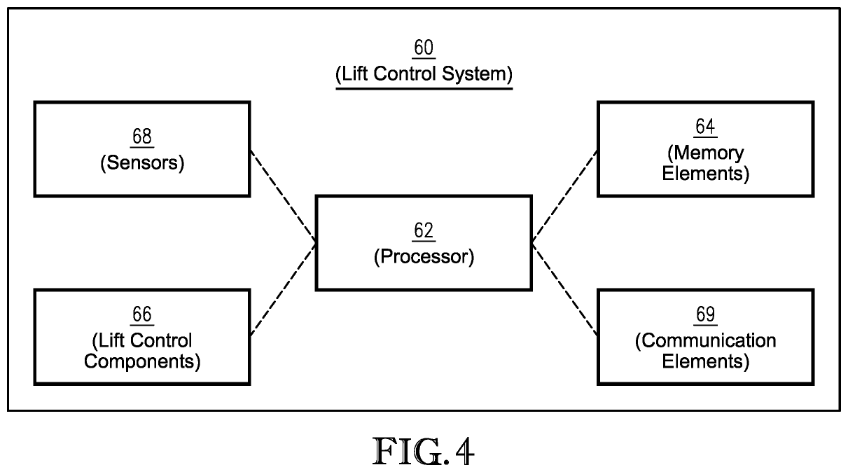

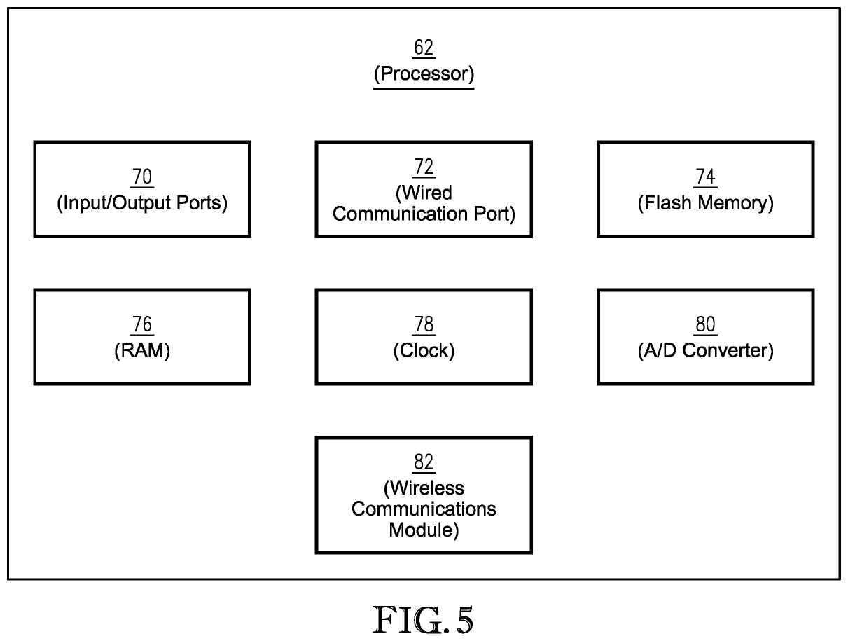

As mentioned above, each of the individual lifts 22 of the portable vehicle lift system 20 will be equipped with a lift control system for controlling the functionality of the lift 22 in response to operator (i.e., user) commands. Such a lift control system 60 is illustrated schematically in FIG. 4, and includes a single, lift processor 62, one or more associated memory elements 64, lift control components 66, sensors 68, and/or communication elements 69. The lift processor 62 is in communication with each of the one or more associated memory elements 64, lift control components 66, sensors 68, and/or communication elements 69. It should be understood that in some embodiments, the single, lift processor 62 is the only processing element of the lift 22. When the lift 22 is part of a lift system 20 comprised of multiple lifts 22, each of the lifts 22 may include only one, lift processor 62.

As described in more detail below, the lift processor 62 is configured to processes lift instructions for its associated vehicle lift 22 (e.g., instructions for raising and lowering the lift 22). For example, the lift processor 62 is configured to process information relating to and for controlling the lift control components 66 and any of the sensors 68 associated with its associated lift 22. The lift control components 66 can include various components, such as the lift actuator 36, a down-stop actuator, an emergency stop actuator, the one or more hydraulic valves, and/or the hydraulic pump 53. The sensors 68 can include a height sensor, a pressure sensor, an energy status sensor, a velocity sensor, an actuator position sensor, a camera, a radar/lidar sensor, an RFID sensor, and the like. The communication elements 69 may be configured to communicate via various networks, with such networks being wired or wireless and may include servers, routers, switches, wireless receivers, transmitters, antennas, and/or transceivers (e.g., Bluetooth or Wi-Fi), and the like, as well as electrically conductive cables or optical cables. The networks may also include local, metro, or wide area networks, as well as the Internet, Intranet, or other cloud networks. Furthermore, the networks may include cellular or mobile phone networks, as well as landline phone networks, public switched telephone networks, various radio frequency (RF) networks, fiber optic networks, serial networks (e.g., USB), or the like. When a lift system 20 includes a plurality of individual lifts 22, the communication elements 69 of each of the lifts 22 may be configured to wirelessly send and receive signals from/to the other of the plurality of lifts 22 in the lift system 20, such that the wireless signals can be used by the lifts 22 to coordinate raising/lowering of a load (e.g., coordinate the heights of each of the carriage assemblies 34 of the lifts 22) during operation of the lifts 22.

In some embodiments, the lift processor 62 may be comprised of various types of processing elements, such as a microprocessor, a microcontroller, a field programmable gate array, and the like, or combinations thereof. In some embodiments, the lift processor 62 will comprise a single-core, dual-core, or quad-core processor configured for simultaneously processing a plurality of different computer programs and/or applications. As such, the lift processor 62 may be operable to implement operating systems, and may generally be capable of executing computer programs, which are also commonly known as instructions, commands, software code, executables, applications, apps, and the like, which may all be stored on the memory elements 64 of the lift 22.

In more detail, each of the vehicle lifts 22 of the lift system may include a single, lift processor 62, which is particularly configured to facilitate both (1) the general operating functions of its associated lift 22 (e.g., to raise loads, to lower loads, to raise/lower loads in cooperation with other lifts 22 of the lift system 20, etc.), and (2) wireless communication to/from the associated lift 22 (e.g., to communicate with other lifts 22 forming part of the lift system 20). As such, both the control and communication functionalities of the vehicle lift 22 will be boarded onto a single processor, which is the lift processor 62 noted above and described in more detail below. Such lift processor 62 may, therefore, be in communication with all of the various lift control components 66 (e.g., hydraulic pumps 53, hydraulic valves, etc. of the lift's hydraulic system) and the communication elements 69 (e.g., transceivers, antennas, etc.) of the lift 22. Furthermore, although the description provided herein generally refers to the lift 22 being hydraulically powered, it is contemplated that the lift processor 62 can control other types of lifts, such as electrical (e.g., battery powered), mechanical (e.g., screw-type), and pneumatic-powered lifts.

To facilitate the necessary functionalities of an associated lift 22 (e.g., lift control and communication), the lift processor 62 may include one or more (or all) of the below-described following features. The lift processor 62 may include at least six (6), at least eight (8), at least ten (10), and/or at least twelve (12) input/output (I/O) ports 70 or pins. Such input/output ports 70 permit communication with the various lift control components 66, sensors 68, and communication system elements 69. For example, the lift processor 62 can receive, via the input/output ports 70, data from the sensors 68 associated with the lift 22. Based on the data obtained from the sensors 68, the lift processor 62 can control various lift control components 66 by transmitting, via the input/output ports 70, to the lift control components 66 (e.g., hydraulic pumps 53, hydraulic valves, etc. of the lift's hydraulic system) instructions for operating the lift (e.g., raising/lowering loads).

In addition, the lift processor 62 may include one or more other wired communication ports 72, such as USB (or other serial communication) ports that allow communication with (i) other components of the lift 22, or (ii) components external to the lift 22. For example, the user controls 54 of the lift 22 may be in wired communication with the lift processor 62 via the serial communication port 72 (e.g., in the form of a USB serial port). In other embodiments, the user controls 54 may be in wireless communication with the lift processor 62 (e.g., via Bluetooth).

In addition, the lift processor 62 may have its own internal memory elements. In some embodiments, the lift processor 62 may comprise at least 32 kB, a least 64 kB, at least 128 kB, and/or at least 256 kB of internal flash memory 74. In addition, the lift processor 62 may comprise at least 12 kB, at least 16 kB, at least 24 kB, at least 32 kB, at least 48 kB, and/or at least 56 kB of internal random access memory (RAM) 76. Such internal memory elements permits sufficient processing capabilities to control both the lift control components 66 and the communication system elements 69 of the lift 22.

In addition, the lift processor 62 may include one or more components that facilitate functional capabilities of the lift 22. For example, the lift processor 62 may include an internal processing clock/timer 78, such as a 16-bit clock. The processing clock/timer 78 may be used to generate pulse-width modulation signals that are used to control one or more of the lift control components 66, such as the hydraulic valves of the hydraulic system. The lift processor 62 may also include an internal analog-to-digital (A/D) converter 80, which may be used to convert analog information to digital data. For example, the lift processor 62 may receive analog information from one or more of the lift's 22 sensors 68, e.g., a string potentiometer height sensor or a load sensor, and the A/D converter 80 may convert such analog information into digital data that can be processed by the lift processor 62 to control the functionality of the lift 22. In some embodiments, the A/D converter 80 of the lift processor 62 may be configured with at least two (2), at least four (4), at least six (6), and/or at least eight (8) analog-to-digital channels. Furthermore, the A/D converter 80 of the lift processor 62 may have a resolution of at least four (4) bits, at least six (6) bits, at least eight (8) bits, at least ten (10) bits, and/or at least twelve (12) bits.

The lift processor 62 may also include an internal wireless communication module 82, such as a RF transceiver module, to facilitate wireless communication with other lifts 22 in the lift system 20. As such, the internal wireless communication module 82 may comprise at least a portion of (or be included as part of) the communication elements 69 of the lift 22. In more detail, the wireless communication module 82 of the lift processor 62 may include an RF transceiver for transmitting and receiving RF signals, such as at a 2.4 GHz frequency. The wireless communication module 82 and/or the processing elements of the lift processor 62 may be configured to process any RF signals received via the transceiver (e.g., signals received from other lifts 22), such as using Wi-Fi, MiFi, Bluetooth, and/or cellular networks. Thus, in some embodiments, the wireless communication module 82 of the lift processor 62 may incorporate internal Wi-Fi, MiFi, Bluetooth, and/or cellular transceivers. In some embodiments, the wireless communication module 82 of the lift processor 62 may be configured to process and/or transfer signals at a rate of at least 250 kB/s, at least 500 kB/s, at least 1000 kB/s, and/or at least 2000 kB/s. The wireless communication module 82 of the lift processor 62 may, in some embodiments, also include a signal converter for converting wireless signals into digital data. In some embodiments, the wireless communication module 82 of the lift processor 62 may be configured to process and/or transfer signals according to a ZIGBEE protocol. Although the above description illustrates how the single, lift processor 62 may include an internal wireless communication module 82 for sending and receiving wireless signals, it is contemplated that the lift processor 62 may also process wireless signals received by the communication elements 69 (e.g., transceivers, antennas, etc.) of the lift 22 that are external to the lift processor 62.

In addition to the above, the lift processor 62 may have other features and/or capabilities, such as the ability to control, send data to, and/or receive inputs from the lift's 22 user control 54 (e.g., to control the information displayed on the graphic display screen and/or touchscreen) and/or to receive inputs from a remote control of the lift 22. Furthermore, the lift processor 62 may be configured to include watchdog functions, such as the capability of monitoring various features of the lift 22 or the lift system 20 for safety requirements and disabling one or more features of the lift 22 or the lift system 20 should an error occur. Furthermore still, the lift processor 62 may be configured to control the battery charger 44 of the lift 22, to facilitate electrical charging of the lift's 22 batteries 42.

Beneficially, the lift processor 62 will preferably be configured to provide such above-described capabilities and functions while operating with reduced processing and power requirements. For example, the lift processor 62 may be configured to operate at an operating frequency of no more than 2 MHz, no more than 4 MHz, no more than 8 MHz, no more than 12 MHz, no more than 16 MHz, no more than 24 MHz, no more than 32 MHz, and/or no more than 48 MHz. Beneficially, the lift processor 62 is configured to operate at such frequencies at a low operating power and/or voltage. For example, in some embodiments, the lift processor 62 may operate (under power provided by the batteries 42) at a reduced voltage range from 1.8 and 3.6 Volts.

In view of the above, embodiments of the present invention may include a vehicle lift 22 with a single, lift processor 62 configured to perform generally all of the necessary control and communications functions of the lift 22. For example, the lift processor 62 may be configured to process both (i) information relate to the lift's 22 lift control components (e.g., to control the hydraulic valves and/or actuators of the lift 22), and (ii) process wireless signals sent and received by the lift 22. As noted, above, the lift 22 may form part of a lift system 20 comprising a plurality of lifts 22. Each of the lifts 22 may have their own singular, lift processer 62 which is configured to perform the necessary control and communications functions of the respective lift 22. In some embodiments, the lifts 22 may each be considered a “stripped-down” lift, which is described herein as a vehicle lift described above, but without one or more (or all) of the following: (i) a touchscreen graphical display, (ii) a remote control, (iii) the capability to use or process lift velocity information (i.e., the speed at which a lift is raising/lower a load), and/or (iv) adaptive wireless communication (i.e., the ability for the communication system elements 69 to automatically select the best or clearest RF frequencies to communicate with other lifts 22).

In more detail, in a stripped down lift, the lift's user control 54 may only include buttons, knobs, and/or switches, as inputs for the user of the stripped down lift to use when operating the lift. If the user control 54 does include a graphical display screen, such screen will only be used to display information and/or will not be in the form of a touchscreen. In addition, the user control 54 may be securely integrated with the housing 38 of the lift (and not removable), such that the stripped down lift does not include and/or is not configured to be used with a remote control. Furthermore, it is understood that some types of MCLs are configured to receive and/or process lift velocity information (i.e., information related to how fast the lifts are raising/lowering loads) when operating a lift and/or cooperatively operating a plurality of lifts within a lift system. However, a stripped down lift will not be configured to use or process such lift velocity information. Finally, it is understood that some types of MCLs are configured with adaptive wireless communication abilities, which permit the lifts to determine and select the best or clearest RF frequencies for communication with other lifts in an associated lift system. However, a stripped down lift will not be configured to use such adaptive wireless communication abilities. Thus, in some embodiments, the single, lift processor 62 described herein may be particularly configured to functionally operate as part of a stripped down lift.

As provided herein, the lifts 22 described above may be part of a wireless portable vehicle lift system 20 comprising at least two portable lifts 22. However, any number of lifts 22 may be included in the lift system 20, such as four (4), eight (8), or more lifts 22. Each of the lifts comprises a base 30, a post 32, a carriage assembly 34, and a lifting actuator 36 for vertically shifting the carriage assembly 34 relative to the post 32 or base 30. Additionally, each of the portable lifts 22 comprises at least a first microprocessor, which may be the lift processor 62 discussed above. Furthermore, the lift system 20 may comprise an electronic control system for controlling the lifts. The electronic control system comprises a wireless communication system for wirelessly communicating inter-lift control signals to, from, and/or among the lifts 22. As such, the wireless communication system may comprise the communication elements 69 (discussed above) of the lifts 22 within the lift system 20. The first microprocessor of each lift 22 (which may comprise the lift processor 62 discussed above) is configured to process information related to the wireless communication system. Furthermore still, each of the lifts 22 comprises an intra-lift control system, which may include one or more lift sensors and/or one or more lift actuators. As such, the intra-lift control system may comprise the sensors 68 and/or the lift control components 66 discussed above. The first microprocessor is further configured to process information related to the intra-lift control system of its respective lift.

### ADDITIONAL CONSIDERATIONS

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, with the exception of the single, lift processor 62, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems or one or more hardware modules of a computer system (e.g., a processor) may be configured by software (e.g., an application or application portion) as computer hardware that operates to perform certain operations as described herein.

In various embodiments, computer hardware, such as a processing element or processor, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Software may accordingly configure the processing element to constitute a particular hardware configuration at one instance of time and to constitute a different hardware configuration at a different instance of time.

More generally, the processing elements or processors described herein may implement operating systems, and may be capable of executing computer programs, which are also generally known as instructions, commands, software code, executables, applications (“apps”), and the like. The memory elements may be capable of storing or retaining computer programs and may also store data, typically binary data, including text, databases, graphics, audio, video, combinations thereof, and the like. The memory elements may also be known as a non-transitory “computer-readable storage medium” and may include (unless otherwise specifically defined herein) random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules. Similarly, the methods or routines described herein may be at least partially processing element-implemented. For example, at least some of the operations of a method may be performed by one or more processing elements or processing element-implemented hardware modules.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A vehicle lift comprising:
a base;
a carriage configured to receive a portion of a vehicle;
an actuator configured to vertically raise and lower said carriage relative to said base,
wherein said vehicle lift is configured to send and receive wireless signals; and
a processor, wherein said processor is configured to (i) control said actuator, and (ii) process the wireless signals.

2. The vehicle lift of claim 1, wherein said actuator is hydraulically powered.

3. The vehicle lift of claim 1, wherein said processor is the only processing element of said vehicle lift.

4. The vehicle lift of claim 1, wherein said vehicle lift is part of a vehicle lift system including a plurality of substantially identical vehicle lifts configured to wirelessly communicate with one another.

5. The vehicle lift of claim 4, wherein the wireless signals are sent and received to/from the plurality of vehicle lifts in the vehicle lift system, and wherein the wireless signals are used to coordinate the heights of each of the vehicle lifts during operation of the vehicle lifts.

6. The vehicle lift of claim 1, wherein said vehicle lift does not include all of the following:
a touchscreen display, a remote control, being configured to process lift velocity information, and being configured with adaptive wireless communication to automatically select radio frequencies.

7. The vehicle lift of claim 1, wherein said processor comprises at least six (6) input output pins configured to receive information from one or more sensors associated with said vehicle lift.

8. The vehicle lift of claim 7, wherein the one or more sensors include a height sensor.

9. The vehicle lift of claim 1, wherein said processor comprises at least six (6) input output pins configured to send information to at least one hydraulic valve associated with said vehicle lift.

10. The vehicle lift of claim 1, wherein said processor includes at least 32 kB of flash memory and at least at least 12 kB of random access memory (RAM).

11. The vehicle lift of claim 1, wherein said processor includes a clock, such that said processor is configured to generate pulse-width modulated (PWM) signals, and wherein the clock has a resolution of at least 8 bits.

12. The vehicle lift of claim 1, wherein said processor includes an analog-to-digital converter configured to convert analog information received from sensors associated with said vehicle lift to digital data, and wherein the analog-to-digital converter has a resolution of at least 4 bits.

13. The vehicle lift of claim 1, wherein said processor operates at a frequency of no more than 48 MHz and operates under electrical power from 1.8 to 3.6 Volts.

14. The vehicle lift of claim 1, wherein the processor includes a wireless communications module configured to send and receive the wireless signals.

15. The vehicle lift of claim 14, wherein the wireless communications module is configured to send and receive the wireless signals over at least one of the following networks: Wi-Fi, Mi-Fi, Bluetooth, and cellular.

16. The vehicle lift of claim 14, wherein the wireless communications module is configured to process the wireless signals at a rate of at least 250 kB/s.

17. The vehicle lift of claim 1, further comprising a user control configured to receive lift instructions from a user of said vehicle lift, wherein said processor includes a communication port in communication with said user control.

18. The vehicle lift of claim 17, wherein said communications port comprises a wired, serial communications port.

19. The vehicle lift of claim 17, wherein said user control include a display screen, and wherein said processor is configured to control said display screen.

20. A wireless portable vehicle lift system comprising:
at least two portable lifts, wherein each of said lifts comprises a base, a post, a carriage assembly, and a lifting actuator for vertically shifting said carriage assembly relative to said post, wherein each of said portable lifts comprises at least a first microprocessor,
wherein said lift system comprises an electronic control system for controlling said lifts, wherein said electronic control system comprises a wireless communication system for wirelessly communicating inter-lift control signals to, from, and/or among said lifts, wherein said first microprocessor is configured to process information related to said wireless communication system,
wherein each of said lifts further comprises an intra-lift control system including one or more lift sensors and/or one or more lift actuators, wherein said first microprocessor is configured to process information related to said intra-lift control system.

21. A vehicle lift comprising:
a base;
a carriage configured to receive a portion of a vehicle;
an actuator configured to vertically raise and lower said carriage relative to said base; and
a processor, wherein said processor includes the following—
input and/or output pins,
flash memory,
random access memory (RAM),
a clock with which said processor is configured to generate pulse-width modulated (PWM) signals,
an analog-to-digital converter, and
a wireless communications module configured to send and receive wireless signals.
